(19) United States
(12) Patent Application Publication
(10) Pub. No.: US 2023/0140001 A1
(43) Pub. Date: May 4, 2023

(54) DISHWASH DETERGENT PRODUCT

(71) Applicant: Conopco, Inc., d/b/a UNILEVER, Englewood Cliffs, NJ (US)

(72) Inventors: Liam Edward DAVIES, Bebington, Wirral (GB); Alexandre François BOUX DE CASSON, Bebington, Wirral (GB); Robert John CARSWELL, Bebington, Wirral (GB); Marina MIXTRO SERRASQUEIRO, Bebington, Wirral (GB)

(73) Assignee: Conopco, Inc., d/b/a UNILEVER, Englewood Cliffs, NJ (US)

(21) Appl. No.: 17/802,551

(22) PCT Filed: Feb. 9, 2021
(86) PCT No.: PCT/EP2021/053096

§ 371 Date: Aug. 26, 2022

(30) Foreign Application Priority Data
Feb. 28, 2020 (EP) 20160173.9

(51) Int. Cl. C11D 3/39; C11D 11/00; C11D 17/04

(52) U.S. Cl. CPC C11D 3/3932; C11D 11/0023; C11D 17/042

(57) ABSTRACT

A unit dose or non-unit dose machine dishwash detergent composition comprising: bleach; bleach activator; from 0.001 to below 0.010 wt. % of a bleach catalyst comprising a manganese complex of formula (A): [LₙMnₘXₚ]^{z}Yq; wherein Mn is manganese, which can be in the II, III, IV or V oxidation state or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule, as well as to a process for washing dishware in a machine dishwasher using said composition and to the use of said composition in a machine dishwasher.

### FIELD OF THE INVENTION

The present invention relates to a machine dishwash detergent product which provides good cleaning at low wash temperatures and which is suitable to comply with the technical Ecolabel criteria as specified in the EU Commission Decision 2017/1216.

### BACKGROUND OF THE INVENTION

Machine dishwash detergent products typically contain several different active components, including builders, surfactants, enzymes and bleaching agents. Surfactants are employed to remove stains and soil and to disperse the released components into the cleaning liquid. Enzymes help to remove stubborn stains of proteins, starch and lipids by hydrolyzing these components. Bleach is used to remove stains by oxidizing the components that make up these stains. In order to reduce the negative effects of in particular calcium and magnesium ions on stain/soil removal so called ‘builders’ (complexing agents) are commonly applied in detergent products.

There is increasing concern about the impact of machine dishwash detergent products on the environment. This means consumers nowadays favor machine dishwash products which have reduced environmental impact during their life cycle. In order to communicate that a machine dishwash detergent product has reduced environmental impact, manufacturers can apply for appropriate recognized certifications, such as the EU Ecolabel (EU Commission Decision 2017/1216 ‘establishing the EU Ecolabel criteria for dishwasher detergents’).

The EU Ecolabel criteria sets-out technical criteria a machine dishwash detergent product must meet in order for a manufacturer to be allowed to apply the Ecolabel certification mark onto their products. The criteria sets-out strong limitations on the type and amounts of many ingredients. For example it sets upper limits of the amount of total non-biodegradable detergent actives as well as outright excluding the presence of others. Examples of not-readily biodegradable detergent actives can be found in the ‘Detergent ingredient database’ list (DID list) available on the EU Ecolabel website (https://ec.europa.eu/environment/archives/ecolabel/pdf/did_list/didlist_part_a_en.pdf).

The problem is that many of these restrictions makes it difficult to provide machine dishwash detergent products which can adequately provide good cleaning of dishware especially at low temperatures. One of the most difficult cleaning challenges in this regard is the adequate removal of tea stains.

MnOx (α-Manganese (II) oxalate dihydrate) is a known bleach catalyst which is not toxic to aquatic life and hence is suitable to be included at normal levels in machine dishwash detergents designed to meet the EU Ecolabel technical criteria. However, it was found that the use of MnOx bleach catalyst at commonly applied concentrations did not provide adequate bleaching in a tested formulation which meets the EU Ecolabel criteria.

It is an object to provide a machine dishwash detergent which meets the technical criteria of the EU Ecolabel (EU Commission Decision 2017/1216 ‘e stablishing the EU Ecolabel criteria for dishwasher detergents’), and which provides adequate removal of tea stains.

It is a further object to provide a machine dishwash detergent which contains a bleach catalyst which provides bleach activity in this machine dishwash detergent composition which meets the technical criteria of the EU Ecolabel (EU Commission Decision 2017/1216 ‘establishing the EU Ecolabel criteria for dishwasher detergents’).

### SUMMARY OF THE INVENTION

One or more of the above objects is achieved in a first aspect of the invention by a unit dose or non-unit dose machine dishwash detergent composition comprising:
bleach;
bleach activator;
from 0.001 to below 0.010 wt. % of a bleach catalyst comprising a manganese complex of formula (A): [LₙMnₘXₚ]^{z}Yq
wherein Mn is manganese, which can be in the II, III, IV or V oxidation state or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule of the general formula:

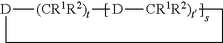

wherein R¹ and R² can each be zero, H, alkyl or aryl optionally substituted; t and t′ are each independent integers from 2-3; each D can independently be N, NR, PR, O or S, where R is H, alkyl or aryl, optionally substituted; and s is an integer from 2-5;

wherein the detergent composition may comprise and if present, if in unit-dose form at most 1 gram, and if in non-unit dose form, at most 14.3 wt. %, in total of the following (i.e. restricted) ingredients:
acrylic acid monomer containing polycarboxylates; phosphonates; polyethylene glycols with a molecular weight of greater than 4000; carboxymethyl inulin (CMI), hydrophobically modified CMC (HM-CMC) and silicone; polyvinylpyrrolidon (PVP); poly(vinylimidazole) (PVI), poly(vinylpyridine-N-oxide) (PVPO) and polyvinylpyrrolidone-vinylimidazole (PVPVI); hydroxyl ethyl cellulose; hydroxy propyl methyl cellulose; benzotriazole; tocopherol acetate; linear polydimethylsiloxanes;

and wherein the detergent composition is free of phosphates; alkyl phenol ethoxylates; atranol; chloroatranol; diethylenetriaminepentaacetic acid (DTPA); ethylenediaminetetraacetic acid (EDTA) and its salts; glutaraldehyde; microplastics; nitromusks and polycyclic musks; perfluorinated alkylates; reactive chlorine compounds; rhodamine B; sodium hydroxyl methyl glycinate; triclosan; 3-iodo-2-propynyl butylcarbamate.

It was surprisingly observed that the use of a bleach catalyst from a selected group of catalysts in a dishwash detergent composition according to the invention and which has a composition which meets the technical EU Ecolabel criteria, provides an adequate bleach performance. The use of such composition containing the bleach catalyst was found to provide an added benefit to tea stain bleaching when compared to compositions not containing such a bleach catalysts. The amount of bleach catalyst is very low, and at levels in the range of 0.001 to below 0.01 wt. % this beneficial effect is still observed.

The invention also relates to a process of washing dishware in a machine dishwasher, comprising the following steps:
a) placing dishware into a machine dishwasher;
b) adding a detergent composition to the machine dishwasher in an amount of from 5 to 50 grams;
c) running the machine dishwasher, which includes bringing into contact the dishware with a wash liquor formed by mixing the detergent composition with water;
d) removing the wash liquor and optionally drying the dishware;

wherein the detergent composition added at step b) comprises:
bleach;
bleach activator;
from 0.001 to below 0.010 wt. % of a bleach catalyst according to the invention;
and is free of phosphates; alkyl phenol ethoxylates; atranol; chloroatranol; diethylenetriaminepentaacetic acid (DTPA); ethylenediaminetetraacetic acid (EDTA) and its salts; glutaraldehyde; microplastics; nitromusks and polycyclic musks; perfluorinated alkylates; reactive chlorine compounds; rhodamine B; sodium hydroxyl methyl glycinate; triclosan; 3-iodo-2-propynyl butylcarbamate;
and wherein the total detergent composition added at step b) comprises, if present, at most 1 gram, and if in non-unit dose form at most 14.3 wt. %, in total of the following ingredients:
acrylic acid monomer containing polycarboxylates; phosphonates; polyethylene glycols with a molecular weight of greater than 4000; carboxymethyl inulin (CMI), hydrophobically modified CMC (HM-CMC) and silicone; polyvinylpyrrolidon (PVP); poly(vinylimidazole) (PVI), poly(vinylpyridine-N-oxide) (PVPO) and polyvinylpyrrolidone-vinylimidazole (PVPVI); hydroxyl ethyl cellulose; hydroxy propyl methyl cellulose; benzotriazole; tocopherol acetate; linear polydimethylsiloxanes.

The invention further relates to use of a bleach catalyst according for enhancing cleaning in detergent compositions according to the invention and meet the technical criteria as set out in the EU Commission Decision 2017/1216 ‘establishing the EU Ecolabel criteria for dishwasher detergents’.

### DETAILED DESCRIPTION OF THE INVENTION

### Definitions

Weight percentage (wt. %) is based on the total weight of the detergent composition unless otherwise indicated or as made clear from the context. It will be appreciated that the total weight amount of ingredients will not exceed 100 wt. %. Whenever an amount or concentration of a component is quantified herein, unless indicated otherwise, the quantified amount or quantified concentration relates to said component per se, even though it may be common practice to add such a component in the form of a solution or of a blend with one or more other ingredients. It is furthermore to be understood that the verb “to comprise” and its conjugations is used in its non-limiting sense to mean that items following the word are included, but items not specifically mentioned are not excluded. Finally, reference to an element by the indefinite article “a” or “an” does not exclude the possibility that more than one of the elements is present, unless the context clearly requires that there be one and only one of the elements. The indefinite article “a” or “an” thus usually means “at least one”. Unless otherwise specified all measurements are taken at standard conditions. Whenever a parameter, such as a concentration or a ratio, is said to be less than a certain upper limit it should be understood that in the absence of a specified lower limit the lower limit for said parameter is 0.

In the context of the present application the term “the composition is free of” or “free of” means that the composition comprises less than 0.1 wt. %, by weight of the total composition, of the specified component(s).

Preferably, the term “the composition is free of” of “free of” means that the composition comprises less than 0.01 wt. %, by weight of the total composition, of the specified component(s), more preferably less than 0.001 wt. % of the specified component(s) and most preferably less than 0.0001 wt. % of the specified component(s).

Preferably, the term “the composition is free of” means that the composition comprises less than 0.1 wt. %, more preferably less than 0.01 wt. % of phosphates; alkyl phenol ethoxylates; atranol; chloroatranol; Diethylenetriaminepentaacetic acid (DTPA); Ethylenediaminetetraacetic acid (EDTA) and its salts; glutaraldehyde; microplastics; nitromusks and polycyclic musks; perfluorinated alkylates; reactive chlorine compounds; rhodamine B; sodium hydroxyl methyl glycinate; triclosan; 3-iodo-2-propynyl butylcarbamate

### Bleach

The composition of the invention preferably comprises from 1 to 25 wt. %, more preferably from 5 to 20 wt. % and even more preferably from 8 to 15 wt. % of bleach. Inorganic and/or organic bleaches can be used. Bleach may be selected from peroxides, organic peracids, salts of organic peracids and combinations thereof.

Examples of peroxides are acids and corresponding salts of monopersulphate, perborate monohydrate, perborate tetrahydrate, and percarbonate. Organic peracids useful herein include alkyl peroxy acids and aryl peroxyacids such as peroxybenzoic acid and ring-substituted peroxybenzoic acids (e.g. peroxy-alpha-naphthoic acid), aliphatic and substituted aliphatic monoperoxy acids (e.g. peroxylauric acid and peroxystearic acid), and phthaloyl amido peroxy caproic acid (PAP). Typical diperoxy acids useful herein include alkyl diperoxy acids and aryldiperoxy acids, such as 1,12-di-peroxy-dodecanedioic acid (DPDA), 1,9-diperoxyazelaic acid, diperoxybrassylic acid, diperoxysebacic acid and diperoxy-isophthalic acid, and 2-decyldiperoxybutane-1,4-dioic acid.

Preferably, the bleach of the present composition is selected from peroxides (including peroxide salts such as sodium percarbonate), organic peracids, salts of organic peracids and combinations thereof. More preferably, the bleach is a peroxide. Most preferably, the bleach is a percarbonate. Further preferred, the bleach is a coated percarbonate.

### Bleach Activators

The detergent composition may contain one or more bleach activators such as peroxyacid bleach precursors. Peroxyacid bleach precursors are well known in the art. As non-limiting examples can be named N,N,N′,N′-tetraacetyl ethylene diamine (TAED), sodium nonanoyloxybenzene sulphonate (SNOBS), sodium benzoyloxybenzene sulphonate (SBOBS) and the cationic peroxyacid precursor (SPCC) as described in U.S. Pat. No. 4,751,015. The detergent composition of the invention preferably comprises from 0.01 to 15 wt. % of bleach activator, more preferably from 0.2 to 10 wt. % and even more preferably from 1.0 to 6 wt. %.

### Bleach Catalyst

Bleach catalysts function by oxidizing typically via peroxide or a peracid to form a bleaching species. They require the presence of an oxidizable soil so that they can be reduced back to the starting bleach activator state.

The bleach catalyst according used in the invention is a manganese complex of formula (A):

[LₙMnₘXₚ]^{z}Yq,

wherein Mn is manganese, which can be in the II, III, IV or V oxidation state or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule of the general formula:

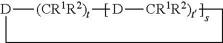

wherein R¹ and R² can each be zero, H, alkyl or aryl optionally substituted; t and t′ are each independent integers from 2-3; each D can independently be N, NR, PR, O or S, where R is H, alkyl or aryl, optionally substituted; and s is an integer from 2-5.

Such bleach catalysts are described in EP0458397A2. The preferred features of the manganese-based bleach catalyst described therein are preferred as well for the purposes of this invention and explicitly belong to the description of this invention. The preferred features referred to are described on pages 3 to 8 of EP0458397A2 in so far as relating to manganese-based bleach catalysts.

The bleach catalysts of the invention are preferably one or more of:
[Mn^{III}₂(μ-O)₁(μ-OAc)₂(TACN)_{2]} (ClO₄)₂;
[Mn^{III}Mn^{IV}(μ-O)₂(μ-OAc)₁ (TACN)_{2]} (BPh4)₂;
[Mn^{IV}₄(μ-O)₆(TACN)_{4]} (ClO₄)₄;
[Mn^{III}₂(μ-O)₁(μ-OAc)₂(Me-TACN)_{2]} (ClO₄)₂;
[Mn^{III}Mn^{IV}(μ-O)₁(μ-OAc)₂(Me-TACN)_{2]} (PF₆)₂;
[Mn^{IV}₂(μ-O)₃(Me/Me-TACN)_{2]} (PF₆)₂;
[Mn^{III}Mn^{IV}(μ-O)₂(μ-OAc)₁(Me-TACN)_{2]} (BPh₄)₂;
[Mn^{IV}₂(μ-O)₃(Me-TACN)_{2]} (PF₆)₂;
[Mn^{III}2(μ-O)(μ-OAc)₂(Me-TACN)_{2]} (ClO₄)₂; and
[Mn^{III}Mn^{IV}₄(μ-O)₁(μ-OAc)₂(Me-TACN)_{2]} (ClO₄)₃.

wherein 1,4,7-trimethy-1,4,7-triazacyclononane is coded as Me-TACN; 1,4,7-triazacyclononane is coded as TACN; 1,5,9-trimethyl-1,5,9-triazacyclododecane is coded as Me-TACD; 2-methyl-1,4,7-trimethyl-1,4,7-triazacyclononane is coded as Me/Me-TACN; and 2-methyl-1,4,7-triazacyclononane is coded as Me/TACN.

Of these the following are the more preferred:
[Mn^{IV}₂(μ-O)₃(Me-TACN)_{2]} (PF₆)₂;
[Mn^{III}₂(μ-O)₁(μ-OAc)₂(Me-TACN)_{2]} (ClO₄)₂;
[Mn^{III}₄(μ-O)₆(TACN)_{4]} (ClO₄)₄; and
[Mn^{III}Mn^{IV}₄(μ-O)₁(μ-OAc)₂(Me-TACN)_{2]} (ClO₄)₃.

The still even more preferred bleach catalyst is Mn^{IV}₂(μ-O)₃(Me-TACN)₂] (PF₆)₂.

The amount of the bleach catalyst is from 0.001 to below 0.010 wt. %, as based on actives levels. The preferred form of adding the bleach catalyst is as of part of a bleach catalyst granule comprising less than 5 wt. % of active bleach catalyst. The use of such granules improves the accurate dosing of the bleach catalyst. The preferred level of the bleach catalyst (i.e. as active) according to the invention is from 0.002 to 0.01 wt. %, preferably from 0.003 to 0.01 wt. %, more preferably from 0.005 to 0.009 wt. %, even more preferred from 0.007 to 0.009 wt. %. The detergent composition may comprise further bleach catalyst of a type not according to the invention, but this is not preferred.

The bleach catalyst is preferably physically separated from the bleach in the detergent composition to prevent premature bleaching. Preferred ways of separating are by incorporation into different solid parts of the detergent composition (e.g. different layers of a tablet) and/or by into different compartments of a multi-compartmental capsule and/or by addition of the bleach catalyst as an encapsulate.

### Surfactant

It is preferred that the detergent product of the invention comprises 0.1 to 30 wt. % of surfactant, more preferably 0.5 to 25 wt. % and even more preferably 1.5 to 15 wt. %. The surfactant can be non-ionic or anionic or a mixture thereof.

The nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of

“Mccutcheon's Emulsifiers and Detergents” published by Manufacturing Confectioners Company or in “Tenside-Taschenbuch”, H. Stache, 2nd Edn., Carl Hauser Verlag, 1981. Preferably the surfactants used are saturated.

### Non-Ionic Surfactants

According to a particularly preferred embodiment, the composition contains from 0.1 to 15 wt. %, more preferably from 0.5 to 10 wt. % and most preferably from 1 to 5 wt. % of a nonionic surfactant or a mixture of two or more non-ionic surfactants. Advantageously a combination of at least two nonionic surfactants is used.

Examples of nonionic surfactants that may be employed in the present composition include the condensation products of hydrophobic alkyl, alkenyl, or alkyl aromatic compounds bearing functional groups having free reactive hydrogen available for condensation with hydrophilic alkylene oxide, such as ethylene oxide, propylene oxide, butylene oxide, polyethylene oxide or polyethylene glycol to form nonionic surfactants. Examples of such functional groups include hydroxy, carboxy, mercapto, amino or amido groups. Examples of useful hydrophobes of commercial nonionic surfactants include C8-C18 alkyl fatty alcohols, C8-C14 alkyl phenols, C8-C18 alkyl fatty acids, C8-C18 alkyl mercaptans, C8-C18 alkyl fatty amines, C8-C18 alkyl amides and C8-C18 alkyl fatty alkanolamides. Accordingly, suitable ethoxylated fatty alcohols may be chosen from ethoxylated cetyl alcohol, ethoxylated ketostearyl alcohol, ethoxylated isotridecyl alcohol, ethoxylated lauric alcohol, ethoxylated oleyl alcohol and mixtures thereof. Examples of suitable nonionic surfactants for use in the invention are found in the low-to non-foaming ethoxylated/propoxylated straight-chain alcohols of the Plurafac™ LF series, supplied by the BASF and the Synperonic™ NCA series supplied by Croda. Also of interest are the end-capped ethoxylated alcohols available as the SLF 18 series from BASF and the alkylpolyethylene glycol ethers made from a linear, saturated C16-C18 fatty alcohol of the Lutensol™ AT series, supplied by BASF. Other suitable nonionics to apply in the composition of the invention are modified fatty alcohol polyglycolethers available as Dehypon™ E127, Dehypon™ 3697 GRA or Dehypon™ Wet from BASF/Cognis. Also suitable for use herein are nonionics from the Lutensol™ TO series of BASF, which are alkylpolyethylene glycol ethers made from a saturated iso-C13 alcohol.

Amineoxide surfactants may also be used in the present invention as anti-redeposition surfactant. Examples of suitable amineoxide surfactants are C10-C18 alkyl dimethylamine oxide and C10-C18 acylamido alkyl dimethylamine oxide.

### Anionic Surfactants

If an anionic surfactant is used, the total amount present preferably is less than 5 wt. %, and more preferably not more than 2 wt. %. Furthermore, if an anionic surfactant is present, it is preferred that an antifoam agent to suppress foaming is present. Examples of suitable anionic surfactants are methylester sulphonates or sodium lauryl sulphate.

### Builders

The builder materials may be selected from 1) calcium sequestrant materials, 2) precipitating materials, 3) calcium ion-exchange materials and 4) mixtures thereof. Water used to provide a wash liquor in the dishwasher usually contains calcium, magnesium, and metallic cations (iron, copper, and manganese). Builders remove the hard water ions typically through precipitation, chelation, or ion exchange. In addition, they help remove soil by dispersion. A beneficial amount of builder is from 10 to 80 wt. %, more preferably from 20 to 75 wt. %, even more preferably from 30 to 70 wt. % and still even more preferably from 40 to 65 wt. %.

Examples of precipitating builder materials include sodium carbonate. Examples of calcium ion-exchange builder materials include the various types of water-insoluble crystalline or amorphous aluminosilicates, of which zeolites are the best known representatives, e.g. zeolite A, zeolite B (also known as zeolite P), zeolite C, zeolite X, zeolite Y and also the zeolite P-type as described in EP-A-0,384,070. Zeolite and carbonate (carbonate (including bicarbonate and sesquicarbonate) are preferred builders, whereof carbonate is the more preferred.

The composition may contain as builder a crystalline aluminosilicate, preferably an alkali metal aluminosilicate, more preferably a sodium aluminosilicate. This is typically present at a level of less than 15 wt. %. Aluminosilicates are materials having the general formula:

0.8-1.5 M₂O·Al₂O₃·0.8-6 SiO₂

where M is a monovalent cation, preferably sodium. These materials contain some bound water and are required to have a calcium ion exchange capacity of at least 50 mg CaO/g. The preferred sodium aluminosilicates contain 1.5-3.5 SiO₂ units in the formula above. They can be prepared readily by reaction between sodium silicate and sodium aluminate, as amply described in the literature. The ratio of surfactants to alumuminosilicate (where present) is preferably greater than 5:2, more preferably greater than 3:1.

Aminopolycarboxylates are well known in the detergent industry and sometimes referred to as aminocarboxylate chelants. They are generally appreciated as being strong builders. Examples include glutamic acid N,N-diacetic acid acid (GLDA), methylglycinediacetic acid (MGDA), ethylenediaminedisuccinic acid (EDDS), iminodisuccinic acid (IDS), iminodimalic acid (IDM), nitrilotriacetic acid (NTA), iminodiacetic acid (IDA), hydroxyethyliminodiacetic acid (HEIDA) aspartic acid diethoxysuccinic acid (AES) aspartic acid-N,N-diacetic acid (ASDA), hydroxyethylene-diaminetetraacetic acid (HEDTA), hydroxyethylethylene-diaminetriacetic acid (HEEDTA), iminodifumaric (IDF), iminoditartaric acid (IDT), iminodimaleic acid (IDMAL), ethylenediaminedifumaric acid (EDDF), ethylenediaminedimalic acid (EDDM), ethylenediamineditartaric acid (EDDT), ethylenediaminedimaleic acid and (EDDMAL), dipicolinic acid.

Preferred aminopolycarboxylate builders are GLDA, MGDA and/or EDDS, of which GLDA and MGDA are the more preferred, and MGDA is even more preferred.

It is advantageous that the builder of the detergent composition comprises a builder selected from at least one of a) aminopolycarboxylate, b) citric acid and/or its alkalimetal salt and and c) carbonate. The builder preferably comprises builders from a) and b); a) and c) or a) and c); and more preferably comprises builders from a), b) and c). Beneficially the detergent composition comprises:
from 5 to 30 wt. % of one or more of GLDA, MGDA;
from 5 to 40 wt. % of citric acid and/or sodium citrate; and
from 10 to 50 wt. % of sodium carbonate.

### Enzymes

It is preferred that the detergent composition of the invention comprises enzymes which degrade, alter or facilitate the degradation or alteration of biochemical soils and stains encountered in cleansing situations so as to remove more easily the soil or stain from the object being washed to make the soil or stain more removable in a subsequent cleansing step. Both degradation and alteration can improve soil removal.

Examples of enzymes suitable for use in the cleaning compositions of this invention include lipases, cellulases, peroxidases, proteases (proteolytic enzymes), amylases (amylolytic enzymes) and others. Well-known and preferred examples of these enzymes are proteases, amylases, cellulases, peroxidases, mannanases, pectate lyases and lipases and combinations thereof. The enzymes most commonly used in detergent compositions are proteolytic and amylolytic enzymes. Enzymes may be added in liquid or in encapsulated form. In a preferred embodiment of this invention the enzymes are present in encapsulated form. Well know enzyme stabilizers such as polyalcohols/borax, calcium, formate or protease inhibitors like 4-formylphenyl boronic acid may also be present in the composition

The proteolytic enzymes in this invention include metalloproteases and serine proteases, including neutral or alkaline microbial serine protease, such as subtilisins (EC 3.4.21.62). The proteolytic enzymes for use in the present invention can be those derived from bacteria of fungi. Chemically or genetically modified mutants (variants) are included. Preferred proteolytic enzymes are those derived from Bacillus, such as B. lentus, B. gibsonii, B. subtilis, B. licheniformis, B. alkalophilus, B. amyloliquefaciens and Bacillus pumilus, of which B. lentus and B. gibsonii are most preferred. Examples of such proteolytic enzymes are Excellase™, Properase™, Purafect™, Purafect™ Prime, Purafect™ Ox by Genencor; and those sold under the trade names Blaze™, Ovozyme™, Savinase™, Alcalase™, Everlase™, Esperase™, Relase™, Polarzyme™ Liquinase™ and Coronase™ by Novozymes. Preferred levels of protease are from 0.1 to 10 mg, more preferably from 0.2 to 5 mg, most preferably 0.4 to about 4 mg active protease per gram of the detergent composition.

The amylolytic enzymes for use in the present invention can be those derived from bacteria or fungi. Chemically or genetically modified mutants (variants) are included. Preferred amylolytic enzyme is an alpha-amylase derived from a strain of Bacillus, such as B. subtilis, B. licheniformis, B. amyloliquefaciens or B. stearothermophilus. Examples of such amylolytic enzymes are produced and distributed under the trade name of Stainzyme™, Stainzyme™ Plus, Termamyl™, Natalase™ and Duramyl™ by Novozymes; as well as Powerase™, Purastar™, Purastar™ Oxam by Genencor. Stainzyme™, Stainzyme™ Plus and Powerase™ are the preferred amylases. Preferred levels of amylase are from 0.01 to 5, more preferably from 0.02 to 2, most preferably from 0.05 to about 1 mg active amylase per gram of the detergent composition.

The enzymes may suitably be incorporated in the detergent composition in liquid or in encapsulated form. In case the composition has a pH of 9.0 and more it is preferred to employ enzymes in encapsulated form. Examples of encapsulated forms are enzyme granule types D, E and HS by Genencor and granule types, T, GT, TXT and Evity™ of Novozymes. In case the pH is less than 9.0 it can be advantageous to employ non-encapsulated enzymes. In accordance with a particularly preferred embodiment of the invention, the composition contains active protease and the protease activity of the freshly prepared composition decreases by not more than 70%, more preferably by not more than 50% and most preferably by not more than 20% when the composition is stored in a closed container for 8 weeks at 20 degrees Celsius.

Advantageously the detergent composition comprises a combination of amylase and protease.

### Dispersing Polymers

In a preferred embodiment of the current invention, the detergent composition comprises at least one dispersing polymer. Dispersing polymers as are beneficially chosen from the group of anti-spotting agents and/or anti-scaling agents. Examples of suitable anti-spotting polymeric agents include hydrophobically modified polycarboxylic acids such as Acusol™ 460 ND (ex Dow) and Alcosperse™ 747 by Nouryon, whereas also synthetic clays, and preferably those synthetic clays which have a high surface area are very useful to prevent spots, in particular those formed where soil and dispersed remnants are present at places where the water collects on the glass and spots formed when the water subsequently evaporates.

Suitable anti-scaling agents are water soluble dispersing polymers prepared from an allyloxybenzenesulfonic acid monomer, a methallyl sulfonic acid monomer, a copolymerizable nonionic monomer and a copolymerizable olefinically unsaturated carboxylic acid monomer as described in U.S. Pat No. 5,547,612 or known as acrylic sulphonated polymers as described in EP851022. Polymers of this type include polyacrylate with methyl methacrylate, sodium methallyl sulphonate and sulphophenol methallyl ether such as Alcosperse™ 240 supplied (Nouryon). Also suitable is a terpolymer containing polyacrylate with 2-acrylamido-2 methylpropane sulphonic acid such as Acumer 3100 supplied by Dow. As an alternative, polymers and co-polymers of acrylic acid having a molecular weight between 500 and 20,000 can also be used, such as homo-polymeric polycarboxylic acid compounds with acrylic acid as the monomeric unit. The average weight of such homo-polymers in the acid form preferably ranges from 1,000 to 100,000 particularly from 3,000 to 10,000 e.g. Sokolan™ PA 25 from BASF or Acusol™ 425 from Dow. Also suitable are polycarboxylates co-polymers derived from monomers of acrylic acid and maleic acid, such as CP5 from BASF. The average molecular weight of these polymers in the acid form preferably ranges from 4,000 to 70,000. Modified polycarboxylates like Sokalan™ CP50 from BASF or Alcoguard™4160 from Nouryon may also be used. Mixture of anti-scaling agents may also be used. Particularly useful is a mixture of organic phosphonates and polymers of acrylic acid.

It is preferable if the level of dispersing polymers ranges from 0.2 to 6 wt. % of the total composition, preferably from 0.5 to 5 wt. %, and further preferred from 1 to 4 wt. %.

Other examples of suitable anti-scaling agents include organic phosphonates, amino carboxylates, polyfunctionally-substituted compounds, and mixtures thereof. Particularly preferred anti-scaling agents are organic phosphonates such as α-hydroxy-2 phenyl ethyl diphosphonate, ethylene diphosphonate, hydroxy 1,1-hexylidene, vinylidene 1,1-diphosphonate, 1,2-dihydroxyethane 1,1-diphosphonate and hydroxy-ethylene 1,1-diphosphonate. Most preferred is hydroxy-ethylene 1,1-diphosphonate (EDHP) and 2-phosphono-butane, 1,2,4-tricarboxylic acid (Bayhibit ex Bayer).

The detergent composition beneficially comprises from 0.5 to 5 wt. % of EDHP, more preferably from 1 to 4 wt. % and even more preferably from 1.5 to 3.0 wt. %

The combined amount of EDHP plus acrylic acid based dispersant polymer preferably is from 1 to 6 wt. %, more preferably from 2 to 5 wt. %.

### Glass Corrosion Inhibitors and Anti-Tarnishing Agents

Glass corrosion inhibitors can prevent the irreversible corrosion and iridescence of glass surfaces in machine dishwash detergents. The claimed composition may suitably contain glass corrosion inhibitors. Suitable glass corrosion agents can be selected from the group the group consisting of salts of zinc, bismuth, aluminum, tin, magnesium, calcium, strontium, titanium, zirconium, manganese, lanthanum, mixtures thereof and precursors thereof. Most preferred are salts of bismuth, magnesium or zinc or combinations thereof. Usual preferred levels of glass corrosion inhibitors in the present composition are 0.01-2 wt. %, more preferably 0.01-0.5 wt. %. Anti-tarnishing agents may prevent or reduce the tarnishing, corrosion or oxidation of metals such as silver, copper, aluminum and stainless steel. Anti-tarnishing agents such as benzotriazole or bisbenzotriazole and substituted or substituted derivatives thereof and those described in EP723577 (Unilever) may also be included in the composition. Other anti-tarnishing agents that may be included in the detergent composition are mentioned in WO 94/26860 and WO 94/26859. Suitable redox active agents are for example complexes chosen from the group of cerium, cobalt, hafnium, gallium, manganese, titanium, vanadium, zinc or zirconium, in which the metal are in the oxidation state of II, II, IV V or VI.

In view of reducing the environmental impact of the detergent composition of the invention the detergent composition is free of zinc and bismuth.

### Binder

The present composition may suitably contain a non-surfactant, water-soluble, liquid binder, e.g. in a concentration of 0-50% by weight of the continuous phase. Examples of such liquid binders include polyethylene glycols, polypropylene glycols, glycerol, glycerol carbonate, ethylene glycol, propylene gylcol and propylene carbonate. Of course, in view of the detergent composition of the invention preferred are polyethylene glycols with a molecular weight of at most 4000. The advantageous amount of polyethylene glycols with a molecular weight of at most 4000 is below 5 wt. % more preferably below 3 wt. %, below 2 wt. %, below 1 wt. % and in fact most beneficially the detergent composition is free of polyethylene glycols.

### Perfume and Colorants

Preferably the detergent product of the invention comprises one or more colorants, perfumes or a mixture thereof in an amount of from 0.0001 to 8 wt. %, more preferably from 0.001 to 4 wt. % and even more preferably from 0.001 to 1.5 wt. %. Perfume is preferably present in the range from 0.1 to 1 wt. %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co. In perfume mixtures preferably 15 to 25 wt. % are top notes. Top notes are defined by Poucher (Journal of the Society of Cosmetic Chemists 6 (2):80 [1955]). Preferred top-notes are selected from citrus oils, linalool, linalyl acetate, lavender, dihydromyrcenol, rose oxide and cis-3-hexanol.

### Further ingredients

The detergent composition of the invention restricts the total amount of a number of not-readily biodegradable ingredients to be at most 14.3 wt. % preferably at most 12 wt. %, more preferably at most 10 wt. %, even more preferably at most 7 wt. %, if the present at all. These ingredients are useful actives in the field of machine dish wash:
acrylic acid monomer containing polycarboxylates (discussed above as dispersing polymer);
phosphonates (discussed above as anti-scalling agent);
polyethylene glycols with a molecular weight of greater than 4000 (discussed above as binder);
polyvinylpyrrolidon (PVP), which may improve the washing power of surfactants;
poly(vinylimidazole) (PVI);
poly(vinylpyridine-N-oxide) (PVPO, also known as PVPNO);
polyvinylpyrrolidone-vinylimidazole (PVPVI)
Zn ftalocyanin sulphate
hydroxyl ethyl cellulose;
hydroxypropyl methyl cellulose;
benzotriazole;
tocopherol acetate,
linear polydimethylsiloxanes.

However, these compounds are not-readily biodegradable under aerobic and anaerobic conditions and hence they tend to undesirably persist in the environment after leaving the dishwasher (e.g. with the dishwasher waste-water stream).

The preferred process of washing dishware in a machine dishwasher using the detergent composition according to the invention is to add a dosage amount of detergent composition which provides at most 1 gram per dose of the combined weight of these not-readily biodegradable compounds.

Hence when the form of the detergent product is in unit-dose form (e.g. a multi-compartmental capsule or a tablet) than the total amount of these not-readily biodegradable ingredients is at most 1 gram, preferably at most 0.8, more preferably at most 0.7 gram, even more preferably at most 0.5 gram per unit dose.

Hence when the form of the detergent product is not in unit-dose form (e.g. as detergent liquid in a pouring bottle or as loose powder in a dosing carton either containing a plurality of dosages) than the total amount of these not-readily biodegradable ingredients is at most 14.3 wt. % based on the total weight of the composition. For such non-unit dose formats the concentration of such not-readily biodegradable ingredients is preferably at most 12.0 wt. %, 10.0 wt. %, 7.0 wt. %, 5.0 wt. %, 3.0 wt. %, 2.0 wt. % and even more preferably at most 1.0 wt. %.

These limitations to the total maximum amount of not-readily biodegradable ingredients preferably also apply to the total maximum amount of not-readily biodegradable ingredients plus the total amount of polyaspartic acid, dyes and perfumes.

Furthermore, in the detergent composition of the invention the amount of:
2-methyl-2H-isothiazol-3-one (MIT) preferably is at preferably at most 0.0050 wt. %;
1,2-Benzisothiazol-3(2H)-one (BIT) is preferably at most 0.0050 wt. %,
5-chloro-2-methyl-4-isothiazolin-3-one/2-methyl-4-isothiazolin-3-one is preferably at most 0,0015 wt. %.

The detergent composition is preferably free of all the following ingredients:
phosphates;
alkyl phenol ethoxylates;
atranol, used as fragrance;
chloroatranol;
Diethylenetriaminepentaacetic acid (DTPA);
Ethylenediaminetetraacetic acid (EDTA) and its salts;
Glutaraldehyde;
Microplastics (i.e. insoluble macromolecular plastics with a maximum length of below 5 mm), not intentionally added, but may be present as impurity;
nitromusks;
polycyclic musks;
perfluorinated alkylates;
reactive chlorine compounds;
rhodamine B;
sodium hydroxyl methyl glycinate;
triclosan;
3-iodo-2-propynyl butylcarbamate.

These compounds are excluded for posing further environmental concerns such as eutrophication (phosphates), allergenicity, (suspected) toxicity and/or other environmental concerns (microplastics).

### Form of the Detergent Product

The detergent product of the invention may be in any suitable form.

The detergent product is preferably provided as a water-soluble or water-dispersible unit dose. Particularly preferred unit doses are in the form of pouches, which comprise at least one further non-shape stable ingredient, such as a liquid and/or powder; or in the form of tablets. For ease of use, the unit dose is sized and shaped as to fit in the detergent cup of a conventional house-hold machine dishwasher as is known in the art. In a preferred embodiment, the unit-dose detergent product has a unit weight of 5 to 50 grams, more preferably a unit weight of 10 to 30 grams, even more preferably a unit weight of 12 to 25 grams and even more beneficially from 15 to 20 grams.

Advantageous unit dose pouches have more than one compartment.

Advantageous unit dose tablets are those which have more than one visually distinct tablet region. Such regions can be formed by e.g. two distinct (colored) layers or a tablet having a main body and a distinct insert, such as forming a nested egg. However oriented, one benefit of using multi-compartmental pouches/multi-region tablets is that it can be used to reduce/prevent undesired chemical reactions between two or more ingredients during storage by physical segregation.

The more preferred unit dose form is a tablet, in particular a multi-layer tablet and even more preferably a multi-layer tablet comprising at least one white part and at least one colored part.

Advantageously the unit dose detergent product is wrapped to improve hygiene and consumer safety. The wrapper advantageously is based on water-soluble film which preferably a polyvinylalcohol (PVA) based film. Preferably, the dishwasher composition is a wrapped unit dose. Such wrapping prevents direct contact of the detergent product with the skin of the consumer when placing the unit dose in the detergent cup/holder of a e.g. machine dishwasher. A further benefit of course is that the consumer also does not need to remove a water-soluble wrapping before use.

In case of the detergent products being in the form of unit doses or non-unit dose powders, the detergent composition is suitably contained in a package. In a preferred embodiment, the package is based on paper (e.g. cardboard). In case of a non-unit dose liquid or gel the package is preferably in the form of a (plastic) bottle with an internal volume of from 100 to 2000 ml and preferably of from 400 to 1600 ml.

The package (i.e. the primary container which holds the detergent product, such as the plurality of unit doses) preferably contains an outwardly visible logo of the EU Ecolabel. The package preferably contains one or more of the following technical information, which are of course, if present, preferably outwardly visible:
Limited impact on the aquatic environment; and/or
Restricted amount of hazardous substances; and/or
Tested for cleaning performance; and/or
Recommended dosage for a standard dishware load; and/or
Information on the reuse, recycling and correct disposal of the packaging.

Of these the following technical information is more preferred:
Information on the reuse, recycling and correct disposal of the packaging

The detergent products according to the invention can be made using known methods and equipment in the field of detergent product manufacturing.

### Process

The invention also relates to a process of washing dishware in a machine dishwasher, comprising the following steps:
a) placing dishware into a machine dishwasher;
b) adding a detergent composition to the machine dishwasher in an amount of from 5 to 50 grams;
c) running the machine dishwasher, which includes bringing into contact the dishware with a wash liquor formed by mixing the detergent composition with water;
d) removing the wash liquor and optionally drying the dishware;

wherein the detergent composition added at step b) comprises:
bleach;
bleach activator;
from 0.001 to below 0.010 wt. % of a bleach catalyst according to the invention and described herein before;
and is free of phosphates; alkyl phenol ethoxylates; atranol; chloroatranol; diethylenetriaminepentaacetic acid (DTPA); ethylenediaminetetraacetic acid (EDTA) and its salts; glutaraldehyde; microplastics; nitromusks and polycyclic musks; perfluorinated alkylates; reactive chlorine compounds; rhodamine B; sodium hydroxyl methyl glycinate; triclosan; 3-iodo-2-propynyl butylcarbamate;
and wherein the total detergent composition added at step b) comprises at most 1 gram, and if in non-unit dose form at most 14.3 wt. % in total of the following ingredients:
acrylic acid monomer containing polycarboxylates; phosphonates; polyethylene glycols with a molecular weight of greater than 4000; carboxymethyl inulin (CMI), hydrophobically modified CMC (HM-CMC) and silicone; polyvinylpyrrolidon (PVP); poly(vinylimidazole) (PVI), poly(vinylpyridine-N-oxide) (PVPO) and polyvinylpyrrolidone-vinylimidazole (PVPVI); hydroxyl ethyl cellulose; hydroxy propyl methyl cellulose; benzotriazole; tocopherol acetate; linear polydimethylsiloxanes.

(Automatic) machine dishwashers have been in use in domestic households for decades. The dishwasher generally operates by subjecting soiled dishware to sequential wash and rinse cycles inside a closed washing chamber. Spray nozzles inside the chamber typically provide direct streams of wash liquor onto the dishware. The force exerted by these streams often cannot match that delivered during hand dishwashing and so consequentially in particular for machine dishwashing there is a need for detergent compositions to provide effective cleaning. As mentioned, correctly so, there is an ongoing need to reduce the environmental impact of operating machine dishwashers using machine dish wash detergents. As such the process of the invention achieves this by providing more effective use of manganese bleach catalyst at very low concentrations while avoiding more than 1 gram per wash of the not-readily biodegradable ingredients in the waste-water stream. Preferably the amount of the not-readily biodegradable ingredients in the waste-water stream is at most 0.8, more preferably at most 0.7 gram, even more preferably at most 0.5 gram per wash.

The preferred amount of detergent composition added at step b) (e.g. in the dishwasher detergent cup) is from 7 to 30 grams, more preferably from 10 to 25 grams and even more preferably from 12 to 20 grams.

It is advantageous that the running of the machine is done at a maximum temperature of 60 degrees Celsius to reduce energy expenditure. The detergent composition of the invention and the process of the invention provide good cleaning in these conditions.

Preferably the machine dish washing process is a domestic machine dish washing process.

### Use of the Detergent Composition

The invention further relates to use of a bleach catalyst according to the invention for enhancing cleaning in detergent compositions which meet the technical criteria as set out in the EU Commission Decision 2017/1216 ‘establishing the EU Ecolabel criteria for dishwasher detergents’.

### Example 1

### Product Manufacture

Powder detergent formulations were made as set out in Table 1:

TABLE 1
powder detergent formulations (wt. % actives):

| | Example 1 | Comparative A | Comparative B |
|---|---|---|---|
| Sodium Carbonate | 35.8 | 35.8 | 35.8 |
| MGDA | 11.6 | 11.6 | 14.9 |
| Sodium percarbonate | 11.4 | 11.4 | 12.9 |
| Citrate (2aq) | 9.9 | 9.9 | 9.9 |
| Sodium Disilicate | 4.0 | 4.0 | 5.0 |
| Non-ionic | 3.6 | 3.6 | 3.6 |
| TAED | 2.8 | 4.5 | 2.8 |
| Acrylic acid-based | 2.8 | 2.8 | 3.1 |
| polymer | | | |
| EHDP | 1.7 | 1.7 | 2.0 |
| Protease | 1.0 | 1.0 | 1.0 |
| Amylase | 0.7 | 0.7 | 0.7 |
| Perfume & dyes | 0.37 | 0.37 | 0.37 |
| ¹Bleach catalyst - | 0.009 | — | — |
| MnCat | | | |
| Bleach catalyst - | — | 0.38 | — |
| MnOx | | | |
| ²Balance | Water & fillers | Water & fillers | Water & fillers |

¹Bleach catalyst MnCat: Mn^{IV}₂(μ-O)₃(Me-TACN)₂] (PF₆)₂
²Balance: does not include any not-readily biodegradable compounds or excluded compounds as described in the invention.

The powder detergent formulations were evaluated for tea stain cleaning performance according to the following method:
Three pre tea-stained tiles (DM14 from the Center For Testmaterials B.V., black tea on melamine) were placed in a machine dishwasher (Miele GSL2) comprising a bottom-rack and a top-rack. Two of the tiles were placed in the bottom rack and one in the top rack. The tiles were fixed in position with an elastic band. One cup of frozen tension soil was further added.
The Machine dishwasher was operated at the following conditions: a single wash programmed at 45 degrees Celsius main wash, 8 min hold, 55 degrees Celsius final rinse, using 18 grams of powder dosed into the dispenser.
The method was independently repeated twice.

### Evaluation of Tea Staining

Each tile was graded visually being given a score of 0 (completely clean) to 10 (same tea-staining as before the wash). The averages of the scores are given below:

| | |
|---|---|
| Example 1 | 4 |
| Comparative A | 6 |
| Comparative B | 6 |

Example 1 cleaning scores were significantly improved versus that using the detergent powder according to Comparative B (and Comparative A). The cleaning scores of Comparative A did not differ significantly from that of Comparative B.

The results show that use of 0.38 wt. % active MnOx in the detergent formulation (which meets the EU Ecolabel restrictions) did not have any observable effect on tea-stain cleaning, whereas use of 0.009 wt. % active MnCat did, even when including about twice the amount of TAED. Hence in these conditions MnCat is at least 400 times as effective (weight for weight) as MnOx.

1. A unit dose or non-unit dose machine dishwash detergent composition comprising:
bleach;
bleach activator;
less than 5 wt. % of anionic surfactant;
from 0.001 to below 0.010 wt. % of a bleach catalyst comprising a manganese complex of formula (A): [LₙMnₘXₚ]^{z}Yq
wherein Mn is manganese, which can be in the II, III, IV or V oxidation state or mixtures thereof; n and m are independent integers from 1-4; X represents a co-ordination or bridging species; p is an integer from 0-12; Y is a counter-ion, the type of which is dependent on the charge z of the complex which can be positive, zero or negative; q=z/[charge Y]; and L is a ligand being a macrocyclic organic molecule of the general formula: 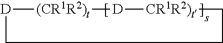
wherein R₁ and R₂ can each be zero, H, alkyl or aryl optionally substituted; t and t′ are each independent integers from 2-3; each D can independently be N, NR, PR, O or S, where R is H, alkyl or aryl, optionally substituted; and s is an integer from 2-5;
wherein the detergent composition comprises, if present, if in unit-dose form at most 1 gram, and if in non-unit dose form at most 14.3 wt. %, in total of the following ingredients:
acrylic acid monomer containing polycarboxylates; phosphonates; polyethylene glycols with a molecular weight of greater than 4000; carboxymethyl inulin (CMI), hydrophobically modified CMC (HM-CMC) and silicone; polyvinylpyrrolidon (PVP); poly(vinylimidazole) (PVI), poly(vinylpyridine-N-oxide) (PVPO) and polyvinylpyrrolidone-vinylimidazole (PVPVI); hydroxyl ethyl cellulose; hydroxy propyl methyl cellulose; benzotriazole; tocopherol acetate; linear polydimethylsiloxanes;
and wherein the detergent composition is free of phosphates;
alkyl phenol ethoxylates; atranol; chloroatranol; diethylenetriaminepentaacetic acid (DTPA); ethylenediaminetetraacetic acid (EDTA) and its salts; glutaraldehyde; microplastics; nitromusks and polycyclic musks; perfluorinated alkylates; reactive chlorine compounds; rhodamine B; sodium hydroxyl methyl glycinate; triclosan; 3-iodo-2-propynyl butylcarbamate; and
wherein the amount of bleach activator is from 0.2 to 6 wt. %.

2. A machine dishwash detergent composition according to claim 1, wherein the bleach catalyst is one or more of [Mn^{IV}₂(μ-O)₃(Me-TACN)_{2]} (PF₆)₂; [Mn^{III}₂(μ-O)₁(u-OAc)₂(Me-TACN)_{2]} (ClO₄)₂; [Mn^{IV}₄(μ-O)₆(TACN)_{4]} (ClO₄)₄ and [Mn^{III}Mn^{IV}₄(μ-O)(μ-OAc)₂(Me-TACN)_{2]} (ClO₄)₃.

3. A machine dishwash detergent composition according to claim 1, wherein the amount of the bleach catalyst according to any preceding claim is from 0.002 to 0.01 wt.

4. A machine dishwash detergent composition according to claim 1, wherein the amount of bleach activator is from 1.0 to 6 wt. %.

5. A machine dishwash detergent composition according to claim 1, wherein the amount of bleach is from 1 to 25 wt. %.

6. A machine dishwash detergent composition according to claim 1, further comprising from 0.1 to 15 wt. % of a nonionic surfactant or of a mixture of two or more nonionic surfactants, wherein mixtures of two or more nonionic surfactants are preferred.

7. A machine dishwash detergent composition according to claim 1, if in unit-dose form at most 0.8, and if not in unit-dose form comprises at most 12.0 wt. % in total of the following ingredients: acrylic acid monomer containing polycarboxylates; phosphonates; polyethylene glycols with a molecular weight of greater than 4000; carboxymethyl inulin (CMI), hydrophobically modified CMC (HM-CMC) and silicone; polyvinylpyrrolidon (PVP); poly(vinylimidazole) (PVI), poly(vinylpyridine-N-oxide) (PVPO) and polyvinylpyrrolidone-vinylimidazole (PVPVI); hydroxyl ethyl cellulose; hydroxy propyl methyl cellulose; benzotriazole; tocopherol acetate; linear polydimethylsiloxanes.

8. A machine dishwash detergent composition according to claim 1, further comprising from 10 to 80 wt. % of builder.

9. A machine dishwash detergent composition according to claim 8 wherein the builder comprises a builder from a) aminopolycarboxylate, b) citric acid and/or its alkalimetal salt or c) carbonate, preferably the builder comprises builders from a) and b); a) and c) or a) and c); and more preferably comprises builders from a), b) and c), wherein GLDA and MGDA are the more preferred builders of the a) aminopolycarboxylates.

10. A machine dishwash detergent composition according to claim 1, further comprising a protease or an amylase and preferably comprising a protease and an amylase.

11. A machine dishwash detergent composition according to claim 1, wherein the machine dishwash detergent composition is a packaged unit dose machine dish wash detergent composition, preferably a wrapped unit dose, more preferably a multicompartmental capsule or a tablet, even more preferably a tablet and still even more preferably a multi-layer tablet.

12. A primary container holding a machine dishwash detergent composition according to claim 1, wherein the container contains technical information regarding one or more of the following:
a) directed to its limited impact on the aquatic environment; and/or
b) the dishwasher composition comprises a restricted amount of hazardous substances; and/or
c) the dishwasher composition has been tested for cleaning performance; and/or
d) a recommended dosage for a standard dishware load; and/or
e) the reuse, recycling and correct disposal of the packaging; wherein technical information on the reuse, recycling and correct disposal of the packaging is preferred.

13. A process of washing dishware in a machine dishwasher, comprising the following steps:
a) placing dishware into a machine dishwasher;
b) adding a detergent composition to the machine dishwasher in an amount of from 5 to 50 grams;
c) running the machine dishwasher, which includes bringing into contact the dishware with a wash liquor formed by mixing the detergent composition with water;
d) removing the wash liquor and optionally drying the dishware;
wherein the detergent composition added at step b) comprises:
bleach;
bleach activator;
less than 5 wt. % of anionic surfactant;
from 0.001 to below 0.010 wt. % of a bleach catalyst of any preceding claim;
wherein the total detergent composition added at step b) comprises, if present, at most 1 gram, and if in non-unit dose form less than 7.0 wt. %, in total of the following ingredients: acrylic acid monomer containing polycarboxylates; phosphonates; polyethylene glycols with a molecular weight of greater than 4000; carboxymethyl inulin (CMI), hydrophobically modified CMC (HM-CMC) and silicone; polyvinylpyrrolidon (PVP); poly(vinylimidazole) (PVI), poly(vinylpyridine-N-oxide) (PVPO) and polyvinylpyrrolidone-vinylimidazole (PVPVI); hydroxyl ethyl cellulose; hydroxy propyl methyl cellulose; benzotriazole; tocopherol acetate; linear polydimethylsiloxanes,
and wherein the detergent composition is free of phosphates; alkyl phenol ethoxylates; atranol; diethylenetriaminepentaacetic acid chloroatranol; (DTPA); ethylenediaminetetraacetic acid (EDTA) and its salts; glutaraldehyde; microplastics; nitromusks and polycyclic musks; perfluorinated alkylates; reactive chlorine compounds; rhodamine B; sodium hydroxyl methyl glycinate; triclosan; 3-iodo-2-propynyl butylcarbamate.

14. The process of washing dishware in a machine dishwasher according to claim 13, wherein the amount of detergent composition added at step b) is from 7 to 30 grams.

15. A Method of using of a bleach catalyst according to claim 1, for enhancing cleaning in detergent compositions which meet the technical criteria as set out in the EU Commission Decision 2017/1216 ‘establishing the EU Ecolabel criteria for dishwasher detergents’.
